(19) United States
(12) Patent Application Publication
(10) Pub. No.: US 2010/0104998 A1
(43) Pub. Date: Apr. 29, 2010

(54) Dental Splint

(75) Inventors: Stanley Edward Farrell, Scottsdale, AZ (US); David Gergen, Peoria, AZ (US)

Correspondence Address: ETHERTON LAW GROUP, LLC, 2010 E. University Drive, Suite 25, Tempe, AZ, 85281, US

(73) Assignee: Stanley Edward Farrell, Scottsdale, AZ (US)

(21) Appl. No.: 12/606,090

(22) Filed: Oct. 26, 2009

Related U.S. Application Data
(60) Provisional application No. 61/197,237, filed on Oct. 25, 2008.

(51) Int. Cl. A61C 7/08; A61C 5/14

(52) U.S. Cl. 433/6; 128/861

(57) ABSTRACT

A removable splint for treating certain orofacial disorders has a chewing surface and can be worn while the patient is eating. The splint fits over some or all of the maxillary or mandibular teeth. The chewing surface is preferably shaped like the occlusal surfaces of the natural teeth of the patient. The device may be made to look like natural teeth and gums. Preferably, the natural look is achieved by coloring the material of the splint during or after casting and placing denture teeth in the part of the splint that shows when the patient smiles.

### CROSS-REFERENCE TO RELATED APPLICATIONS

This application claims the benefit of co-pending provisional application No. 61/197,237 filed Oct. 25, 2008.

### FIELD OF INVENTION

This invention relates to the treatment of orofacial disorders. This invention relates particularly to an apparatus worn by a patient used in treating the disorders.

### BACKGROUND

The study of orofacial disorders has revealed that many chronic problems in the head and neck, such as headaches and migraines, jaw pain, muscle spasms, and neurological problems such as dystonia, have a common cause in the function or malfunction of the jaw. Two orofacial disorders in particular, temporomandibular joint disorder (“TMD”) and malocclusion of the teeth, are widespread among the public and responsible for a significant amount of orofacial pain in patients seeking care by dental and medical professionals. One cause of TMD is a malfunctioning temporomandibular joint (“TMJ”). The malfunction itself may have many causes, including joint disease such as arthritis, night-grinding of the teeth known as bruxism, jaw injuries, muscle tension, and malocclusion of the teeth. TMD causes headaches, earaches, jaw and neck pain, clicking and popping in the TMJ, and abnormal opening and closing of the jaw.

Among the known approaches to treating TMD, the most common are having the patient wear a splint and having the patient undergo surgery, the latter being a last resort for most patients. A TMJ splint typically fits over the maxillary or mandibular teeth of the patient, and has a specifically-designed thickness that keeps the jaws apart and allows the jaw muscles to relax, relieving pressure on the TMJ. While known splints are effective at relieving TMD symptoms, they suffer from two major drawbacks: first, they cannot be worn while eating; and second, they are unattractive while worn.

Known splints have smooth external surfaces that make them unable to masticate food against the opposing teeth. Thus, the patient must remove the splint to eat. Some patients have such debilitating TMD that doing this causes them a great deal of pain. Further, the acts of biting and chewing are impactful on the TMJ, so not having the splint in place for these motions exacerbates the TMD symptoms. A TMJ splint that allows a patient to eat while wearing it is needed.

Because known splints cannot be worn while eating, they cannot be used to address the malocclusion of teeth, which many TMD sufferers have. Malocclusion means the teeth of the maxilla do not align properly with the teeth of the mandible during a bite. The occlusal surfaces of the teeth come into contact unevenly, causing a poor distribution of the bite pressure among the teeth. This problem can cause or exacerbate TMD and can also cause tooth pain and tooth damage. A splint that addresses malocclusion of teeth is needed.

Most known splints are designed for nighttime or daytime use. Night guards are designed without aesthetics in mind. Daytime splints are typically clear, to reduce their negative cosmetic impact. However, clear splints are still highly visible. Many patients dislike wearing a splint because of how it makes them look. A splint that has no impact or a positive impact on the patient's appearance is needed.

Therefore, it is an object of this invention to provide a device that treats orofacial disorders and can be worn even while eating. It is a further object that the device provides an even distribution of bite pressure. Another object of this invention is to provide an orofacial device that is not unsightly. A further object is to provide a device that improves the appearance of the patient's mouth.

### SUMMARY OF THE INVENTION

A removable splint for treating certain orofacial disorders has a chewing surface and can be worn while the patient is eating. The splint covers some or all of the maxillary or mandibular teeth. The chewing surface is preferably shaped like the occlusal surfaces of the natural teeth of the patient. The device may be made to look like natural teeth and gums. Preferably, the natural look is achieved by coloring the material of the splint during or after casting and placing denture teeth in the part of the splint that shows when the patient smiles. Alternatively, natural-looking teeth are sculpted into the splint and the splint is colored to resemble teeth and gums. The splint is used in a method for treating orofacial disorders, such as temporomandibular joint syndrome. A dental professional orders the casting of the splint based on measurements unique to the patient. The dental professional fits the splint to the patient and makes any necessary adjustments.

### BRIEF DESCRIPTION OF THE DRAWINGS

FIG. 1 is a front view of the preferred embodiment of the present invention.

FIG. 2 is a top perspective view from the front left side of the preferred embodiment of the present invention.

FIG. 3 is a top view of the preferred embodiment of the present invention.

FIG. 4 is a bottom perspective view from the rear left side of the preferred embodiment of the present invention.

FIG. 5 is a rear view of the preferred embodiment of the present invention.

FIG. 6 is a right side view of the preferred embodiment of the present invention.

FIG. 7 is a right side sectional view of FIG. 6 taken along line 7-7 of FIG. 3.

### DETAILED DESCRIPTION OF THE INVENTION

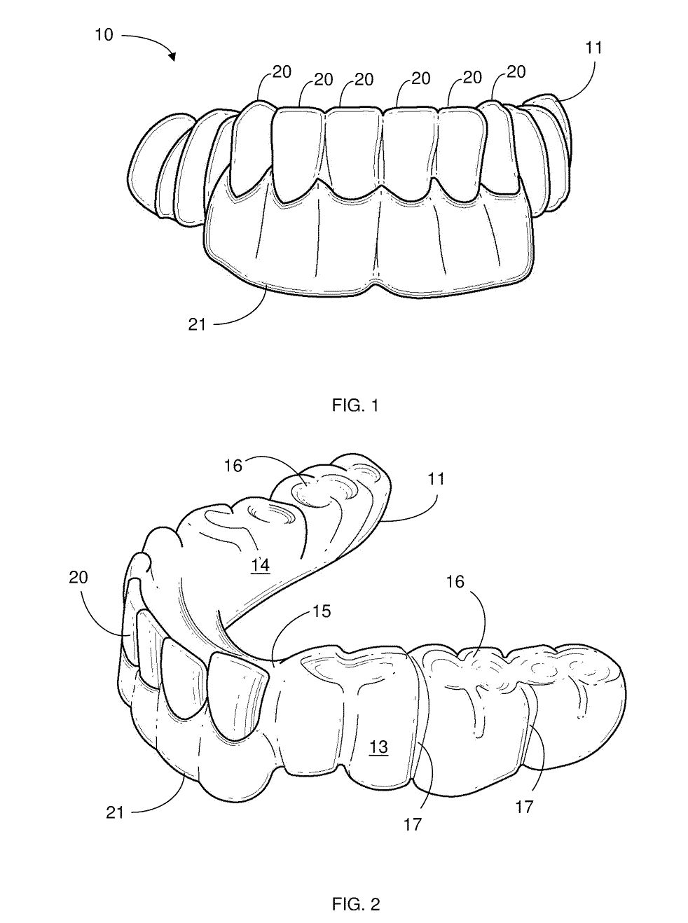

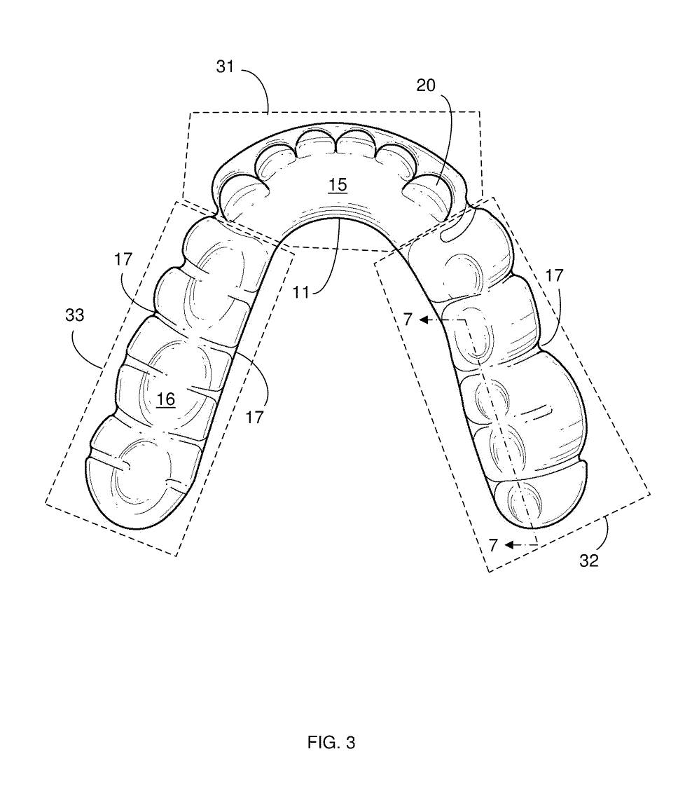

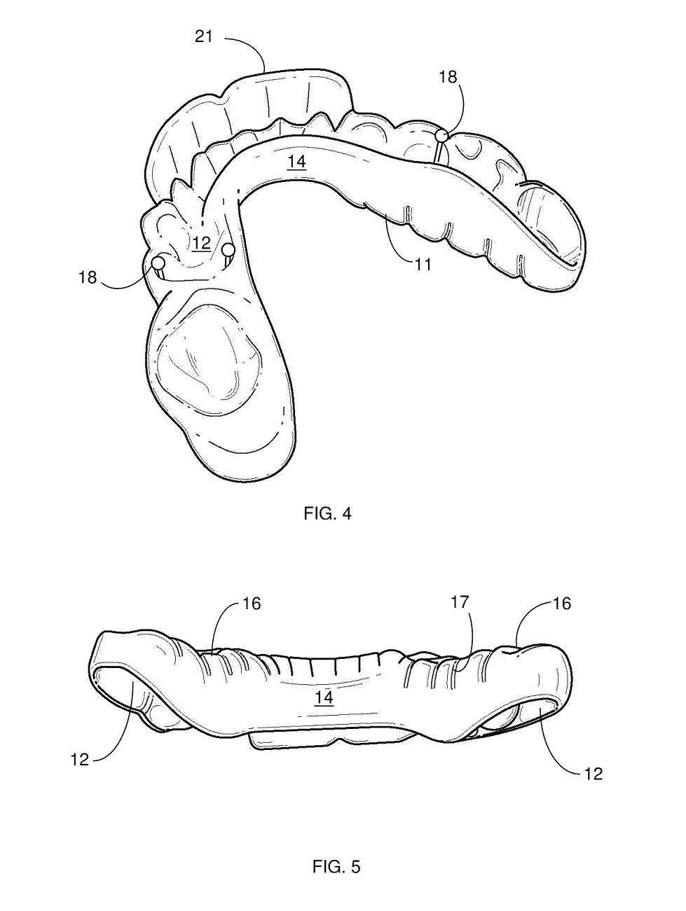

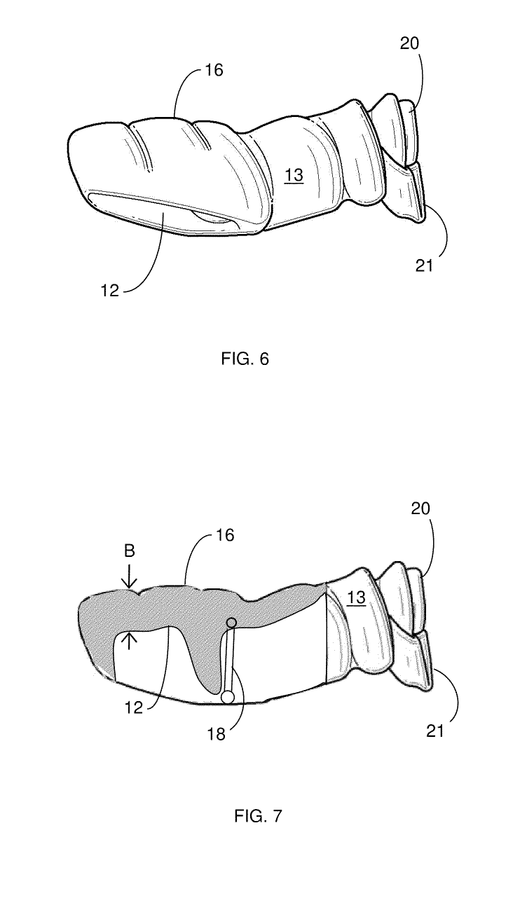

Referring to FIGS. 1-7, there is illustrated the preferred embodiment of the present orofacial device designated generally as 10. The device 10 is used to treat orofacial disorders including malocclusion of the teeth; disorders and pain of the TMJ; muscle spasms and pain in the head and neck; neurological disorders of the head and neck, such as dystonia; and various types of headaches, including migraines. A removable splint 11 is formed or cast from a mold according to the mouth measurements of a patient that will wear the device 10. The splint 11 may be made of a hard, substantially inflexible material, such as plastic, including thermoplastic suck-down material; porcelain; metal; or heat-cured or cold-cured acrylic. Preferably, the splint is cast in a combination of cold- and heat-cured acrylic from a mold. The splint 11 may be cast in a single pour, or may be divided into segments that are later attached together, as in the preferred embodiment described below. The splint 11 may be designed to relieve pressure in the TMJ by opening the joint, to stretch or relax the jaw muscles, to reposition the mandible with respect to the maxilla, to account for a malocclusion of teeth, or to perform a combination of these functions. The splint 11 may be removable, such as for cleaning, but is designed to remain in place at substantially all times during treatment. The splint 11 may also be fit with one or more dental clasps 18, which are used to adjust the fit of the device 10 and help retain it in the mouth. The clasps 18 may be plastic or metal, and are preferably chromium. The clasps may be set during the casting of the splint 11, or they may be otherwise attached thereafter.

The splint 11 is designed to fit over or substantially cover some or all of the maxillary or mandibular teeth. In the preferred embodiment, the splint 11 covers all of the patient's mandibular teeth. The splint 11 has an internal surface 12 that is preferably cast from a set of impressions of the patient's mandibular teeth. The internal surface 12 thereby conforms to the patient's teeth, helping to hold the splint 11 in place. Alternatively, the internal surface 12 may be substantially smooth or otherwise free of impressions. The splint has a facial surface 13 and a lingual surface 14. The facial surface 13 and lingual surface 14 may span the entire splint 11 and connect at the back of the splint 11, or the splint 11 may remain open at the back. In the preferred embodiment, the splint 11 has both a facial surface 13 and a lingual surface 14 that connect at the back of the splint 11. The splint 11 also has an occlusal surface 15 that connects to the facial surface 13, the lingual surface 14, or, preferably, both. The occlusal surface 15 spans the splint 11 above the teeth, covering the teeth.

A chewing surface 16 is formed into a portion or the entirety of the occlusal surface 15. Preferably, the chewing surface 16 is formed into the molar portion of the occlusal surface 15, which lies above the patient's molars and wisdom teeth, if present. The chewing surface 16 may further lie above the patient's bicuspids. The chewing surface 16 is preferably integral with the splint 11 and preferably made from the same material as the splint 11. The chewing surface 16 engages the teeth on the opposing jaw bone, particularly when the patient is eating. The chewing surface 16 may be shaped to help the patient chew food, and may further be shaped to account for any malocclusion of teeth. To help with chewing food, one or more cusps and grooves may be formed into the chewing surface 16. Preferably, the cusps and grooves are formed into the chewing surface 16 so that the chewing surface 16 is shaped substantially like the occlusal surfaces on the patient's molars and bicuspids. To further facilitate chewing and swallowing of food, some or all of the facial surface 13, lingual surface 14, and occlusal surface 15 may have grooves 17 formed in them to emulate the separation between natural teeth. Preferably, the facial surface 13 and lingual surface 14 have grooves 17 representing typical molars and bicuspids.

The splint 11 may be cast with a desired separation thickness, which is the depth of splint 11 material between the internal surface 12 and the chewing surface 16. For example, FIG. 7 illustrates a separation thickness B for a part of the splint 11 that lies above the patient's right-side molars. The separation thickness creates space between the teeth in the patient's opposing jaw bones, having a therapeutic effect on the TMJ by opening the joint and relieving pressure on it. The separation thickness may be constant or varying throughout the splint 11, depending on the intended treatment. Preferably, the separation thickness varies throughout the splint 11. Further, the splint 11 may be relatively thinner between the internal surface 12 and the facial surface 13 and between the internal surface 12 and the lingual surface 14, in order to reduce the impact of the splint 11 on the patient's cheeks and lips. Preferably, there is at least 1.5 mm of splint 11 material between the internal surface 12 and the facial surface 13 and lingual surface 14.

Malocclusion of teeth in the patient's bite may be addressed by casting the splint 11 and chewing surface 16 in the shape and dimensions needed to create a desired proper occlusion between the device 10 and the opposing teeth. The necessary shape and dimensions are determined by measuring the patient's bite with known standard and protrusive bite registration processes, such as by using a facebow transfer and a dental articulator, and then choosing the desired occlusion. The desired occlusion may be any known occlusal profile, including a linear occlusion, flat plane occlusion, cusp occlusion, or ideal occlusion, that is appropriate for the course of treatment. The different occlusal profiles are obtained by setting the dental articulator for the desired occlusion and aligning the articulator with the patient's face. Preferably, an ideal occlusion is obtained when the chewing surface 16 is positioned relative to the opposing teeth such that the opposing teeth have proper cusp contact and bite pressure is evenly distributed throughout the jaw. To create an ideal occlusion, a cast of the opposing teeth is taken, and the chewing surface 16 is shaped to be substantially complementary to the occlusal surfaces of the opposing molars and bicuspids.

The device 10 may be designed to have a neutral or positive impact on the appearance of a patient's face, including some or all of the mouth, lips, cheeks, chin, and jawline. To minimize visibility of the splint 11, the splint 11 may be made of a tooth-colored material. Preferably, the color of the material is matched to the color of the opposing teeth, although the color can be made brighter or otherwise mismatched with the opposing teeth to improve the patient's appearance. Further, the device 10 may comprise one or more natural-looking teeth 20 that are either integral with the splint 11 or attached after the splint 11 is formed. The natural-looking teeth 20 may span only a portion of the splint 11 or may span the entire splint 11. Preferably, the incisors and canines are formed with natural-looking teeth 20. The natural-looking teeth 20 may be formed and positioned so they appear to be the patient's real teeth, or may have improved alignment to improve the appearance of the patient's mouth. The attached teeth 20 may be any hard, prefabricated or custom-cast teeth, and may be made of plastic, acrylic, metal, porcelain, or another dental composite material. In the preferred embodiment, the teeth 20 are denture teeth that are hollowed out to form shells that fit over or cover the patient's real teeth. In alternate embodiments, the splint 11 may be heat-cured acrylic or thermoplastic suck-down material, and the natural-looking teeth 20 are cast with the splint 11 and sculpted out of the splint 11 material before it hardens. A gum portion 21 may also be attached to or cast with the splint 11. Preferably, the gum portion 21 is positioned below the natural-looking teeth as in an actual mouth. The gum portion 21 is preferably the same color as the patient's gums to maximize the natural appearance of the patient's mouth. In the preferred embodiment, the gum portion 21 is made of the same acrylic as the splint 11. In alternate embodiments, the gum portion 21 may be a hard or soft material such as thermoplastic suck-down material, flexible polymer, or cosmetic gel, that can be made to look and feel like the patient's gums.

In order to treat a patient having one or more orofacial disorders, a dental professional first evaluates the patient to determine that the device 10 will relieve the patient's symptoms, repair any damage, or correct malfunctions in the jaw or teeth. The dental professional then takes measurements of the patient's mouth, typically by having the patient bite down onto impression material as is known in the art. The dental professional also determines the appropriate thickness of the splint 11 and the appropriate shape of the chewing surface 16 and adds them to the mouth measurements. Using the measurements, the device 10 is cast.

To cast the preferred device 10, a model of the patient's teeth is made from the impressions. In the preferred embodiment, the natural-looking teeth 20 are denture teeth selected based on the measurements to enable the device 10 to function properly. The denture teeth are made to fit over the corresponding teeth on the model, by hollowing out the denture teeth. The natural-looking teeth 20 are then secured to the model in the desired position and a matrix is formed around the mandibular teeth, according to the measurements, to create a boundary for the device mold.

With the matrix in place, the mold is blocked off from the bicuspids to the backmost teeth to retain the acrylic in the anterior part of the mold, and clear cold-cured acrylic is poured around the natural-looking teeth 20, creating an anterior segment 31 of the device 10. The clear acrylic provides some translucency between the natural-looking teeth 20 to give the device 10 a more natural appearance. The blocking and pouring process is then repeated, using the preferred tooth-colored acrylic, to create a right segment 32 and a left segment 33 of the device 10. The chewing surface 16 is then formed by placing the model maxillary teeth onto the uncured acrylic of the right and left segments 32, 33 and curing the acrylic. After curing, all three segments 31, 32, 33 are placed on the model and ground down to fit together. A body wire, most preferably a 0.040 inch wire, is burred into the segments 31, 32, 33 to hold them together, and a thin layer of clear acrylic is poured into the mold and cured to fuse the segments 31, 32, 33 into the splint 11. The gum portion 21 is then added to the splint 11 at the anterior segment and cured, and the device 10 is polished.

After the device 10 is cast, the dental professional tests the device 10 by placing it in the patient's mouth over the appropriate teeth. Depending upon the course of treatment, the patient may feel an immediate effect, such as when the device 10 relieves pressure on the TMJ. If the device 10 is intended to address a malocclusion of teeth, the dental professional may perform an occlusal test to ensure that the device 10 meets the opposing teeth properly when the patient bites. Another part of testing the device 10 is confirming with the patient that the patient can eat food without discomfort while the device 10 is in place. Additionally, the dental professional may evaluate the appearance of the device 10 to verify that the natural-looking teeth 20 are properly aligned and the coloration of the device 10 is substantially accurate. The dental professional may adjust the device if the patient reports that the device 10 is uncomfortable or loose. Adjusting the device may require repositioning the clasps 18 to fit the patient's mouth, or may require more extensive modification of the device 10, perhaps even recasting of the device 10. For example, the dental professional may use a low-speed handpiece or another dental drill with an acrylic burr attached to resurface any of the surfaces 12, 13, 14, 15, 16, improving the fit or occlusion. As the dental professional adjusts the device 10 for proper use in the patient's treatment, he reviews each step with the patient to ensure that the device 10 fits properly and that the patient is experiencing the desired relief while wearing the device 10.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

What is claimed is:

1. A device for treating orofacial disorders comprising a removable splint with a chewing surface.

2. The device of claim 1 wherein the splint has a thickness that is therapeutic to a patient with an orofacial disorder.

3. The device of claim 1 wherein the splint substantially covers a patient's mandibular teeth.

4. The device of claim 1 wherein the splint substantially covers a patient's maxillary teeth.

5. The device of claim 1 wherein the chewing surface is shaped similarly to an occlusal surface of human teeth.

6. The device of claim 5 wherein the splint has a molar portion that covers the patient's molars, the chewing surface of the molar portion having substantially the same shape as the occlusal surface of the patient's molars.

7. The device of claim 5 wherein the chewing surface is substantially complementary to the occlusal surfaces of the opposing teeth.

8. The device of claim 1 wherein the splint has a facial surface and the facial surface is shaped similarly to a facial surface of human teeth.

9. The device of claim 1 wherein the splint further comprises at least one natural-looking tooth.

10. The device of claim 9 wherein the natural-looking tooth is sculpted into the splint.

11. The device of claim 9 wherein the natural-looking tooth is a hollowed denture tooth.

12. The device of claim 11 wherein the denture tooth is integral with the splint.

13. The device of claim 11 wherein the denture tooth is attached to the splint.

14. An oral appliance comprising:
a) a splint configured to substantially cover a patient's mandibular teeth, the splint having a right segment, a left segment and an anterior segment;
b) a chewing surface integral with the splint, the chewing surface having substantially the same shape as the occlusal surface of the patient's teeth it covers.

15. The oral appliance of claim 14 where in the right segment is integral with the anterior segment and the anterior segment is integral with the left segment.

16. The oral appliance of claim 14 further comprising a denture tooth in the anterior segment.

17. An oral appliance device comprising:
a) a removable splint covering a patient's teeth, the splint having a right segment, a left segment and an anterior segment, wherein:
i. the right and left segments are tooth-colored;
ii. the anterior segment has at least one portion that is gum-colored; and
iii. the right segment is fused with the anterior segment and the anterior segment is fused with the left segment.
b) a chewing surface integral with the splint, wherein the chewing surface of the portion of the splint that covers the patient's molars has substantially the same shape as the occlusal surface of the patient's molars; and
c) in the anterior portion, at least one denture tooth adapted to cover a patient's tooth.

18. The device of claim 17 further comprising a body wire running from the right segment to the anterior segment and from the anterior segment to the left segment.

19. The device of claim 17 further comprising a clasp.

20. The device of claim 17 wherein the removable splint covers the patient's mandibular teeth.
